(19) United States
(12) Patent Application Publication
(10) Pub. No.: US 2007/0172051 A1
(43) Pub. Date: Jul. 26, 2007

(54) Setting up a packet-oriented multimedia connection using an interactive voice response system

(76) Inventor: Klaus Hoffmann, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/588,898

(22) PCT Filed: Feb. 8, 2005
(86) PCT No.: PCT/EP05/50532

§ 371 Date: Aug. 10, 2006

(30) Foreign Application Priority Data
Feb. 11, 2004 (DE) 10 2004 006 756.2

(51) Int. Cl. H04M 1/00; H04M 3/00

(52) U.S. Cl. 379/360

(57) ABSTRACT

In one aspect, a communication set up between subscribers by means if an interactive voice response system is provided. The generation of a recall of the subscriber is controlled by signalling messages serving to warn the subscriber of a call. A direct link TDM, RTP/RTCP<SB>A/B</SB> in the multimedia network is set up between the two subscribers at latest when the communication is set up. Thus, it is possible to provide intelligent IVR network power characteristic of the PSTN network power in a multimedia packet transmission multimedia network, such that a recall is properly displayed. The PSTN network power in a multimedia packet transmission multimedia network, such that a recall is properly displayed. The direct TDM, RTP/RTCP<SB>A/B</SB> link further enables the IVR system to be significantly free of load.

### CROSS REFERENCE TO RELATED APPLICATIONS

This application is the US National Stage of International Application No. PCT/EP2005/050532, filed Feb. 8, 2005 and claims the benefit thereof. The International Application claims the benefits of German application No. 102004006756.2 DE filed Feb. 11, 2004, both of the applications are incorporated by reference herein in their entirety.

### FIELD OF INVENTION

The present invention relates to setting up a packet-oriented multimedia connection using an Interactive Voice Response System.

### BACKGROUND OF INVENTION

In the past two major types of communication network have evolved for the transmission of information: packet-oriented (data) networks and line-oriented (voice) networks. As a result of the convergence of these two types of network, convergent multimedia networks have evolved. Hybrid networks are the result of the amalgamation of these different types of network.

Line-oriented networks—also referred to as voice networks, telephone networks or Public Switched Telephone Networks (PSTN)—are designed for the transmission of continuous streams of (voice) information, also referred to among experts as speech connections or calls. Information is hereby generally transmitted with a high quality of service and security. For voice, for example, a minimum—e.g. <200 ms—delay without delay jitter is important, as voice requires a continuous information flow when played back in the receive device. Information loss cannot therefore be compensated for by re-transmission of untransmitted information and generally results in acoustically perceptible interference (e.g. clicking, distortion, echo, silence) in the receive device. Among experts voice transmission is generally also referred to as a realtime (transmission) service or a realtime service.

Packet-oriented networks—also referred to as data networks—are designed for the transmission of packet streams also referred to among experts as data packet streams, sessions or flows. A high quality of service does not generally have to be guaranteed here. Without a guaranteed quality of service the data packet streams are transmitted for example with delays that fluctuate over time, as the individual data packets of the data packet streams are generally transmitted in the sequence of their network access, i.e. the time delays become longer, the more packet there are to be transmitted from a data network. Among experts the transmission of data is therefore also referred to as a non-realtime service.

The packets are generally differentiated according to the type of packet-oriented network. They can for example be configured as Internet, X.25 or Frame Relay packets or even as ATM cells. They are also sometimes referred to as messages, primarily when a message is transmitted in a packet.

One known data network is the Internet. Because the Internet Protocol IP is used there, it is sometimes also referred to as the IP network, with this term being understood essentially in a broad sense and covering all networks in which the IP Protocol is used. The Internet is conceived as an open (long-range) data network with open interfaces for the connection of (generally local and regional) data networks of different vendors. It provides a vendor-independent transport platform.

Connections are communication relations between at least two subscribers for the purposes of—generally mutual, i.e. bi-directional information transmission. The subscriber initiating the connection is generally referred to as the ‘A-subscriber’. A subscriber connected to an A-subscriber by means of a connection is referred to as a ‘B-subscriber’. In a connectionless network connections represent at least the relation between A-subscribers and B-subscribers that is unique at a logically abstract level, in other words according to this view for example the connectionless flows in the Internet represent logically abstracted connections (e.g. A-subscriber=browser and B-subscriber=web server). In a connection-oriented network at a physical level connections also represent unique paths through the network, along which the information is transmitted.

Signaling serves to align network components but not for the “actual” transmission of information as described above. The information transmitted for signaling purposes is generally referred to as signaling information, signaling data or just as signaling. The term should thereby be understood in the broad sense. It also includes for example messages to control Registration, Admission and Status (RAS), messages to control useful channels of existing calls (e.g. according to the standard H.245) and all further similarly configured messages. The “actual information” is also referred to as useful information, payload, media information, media data or just media, to differentiate it from signaling. Communication relations, which serve to transmit signaling, are hereafter also referred to as signaling connections. The communication relations used for the transmission of useful information are referred to for example as speech connections, useful channel connections or simply useful channels, bearer channels or just bearers.

In this context out-of-band or outband is used to refer to the transmission of information on a path/medium other than the one provided in the communication network for the transmission of signaling and useful information. In particular it includes a local configuration of devices on site, effected for example using a local control device. In contrast, in the case of in-band, information is transmitted on the same path/medium, optionally logically separated from the signaling and useful information in question.

As a result of the convergence of voice and data networks, voice transmission services and increasingly also broader band services such as the transmission of moving image information are also implemented in packet-oriented networks. In other words, realtime services that were previously generally transmitted in a line-oriented manner are transmitted in a convergent network—also referred to as a voice/data network or multimedia network—in a packet-oriented manner, i.e. in packet streams. These are also referred to as realtime packet streams. The transmission of voice information via a packet-oriented IP network is thereby also referred to as ‘VoIP’ (Voice over IP).

A number of distributed architectures for multimedia networks, initially based on homogenous multimedia networks, are described in the international standardization bodies IETF (Internet Engineering Task Force) and ITU (International Telecommunications Union).

At the ITU the transport of voice, data and video streams via an IP network is defined in the relevant standard H.323, on which this is based. Audio and video streams are thereby transmitted according to the protocol RTP/RTCP. Connection control is brought about by means of the protocol H.225 for example, which allows the signaling, registration and synchronization of media streams. The H.323 architecture primarily provides the following types of function units:
Terminal, e.g. in a Local Area Network (LAN), for bi-directional realtime communication with other terminals,
Gatekeeper to implement connection control,
Media Gateway (MG) at the interface with other networks to convert from H.323 formats to the formats of these networks,
Media Gateway Controller (MGC) to control Media Gateways, in particular their respectively transmitted connections, with the aid of the protocol H.248 and to convert between different signaling protocols.

At the IETF telephony via the Internet is standardized in the Session Initiation Protocol (SIP), with which interactive connections can be provided via the Internet. SIP supports connection control and the translation of SIP addresses to IP addresses. SIP is based on relatively intelligent endpoints, which themselves implement many signaling functions. When a connection is set up with the aid of SIP, a description of the bearer is generally exchanged between both sides of the connection. The Session Description Protocol (SIP) according to the standard RFC2327 is used to this end. Such use is for example described in the standard RFC3264: “An Offer/Answer Model with the Session Description Protocol (SDP)”. The following bearer data is of primary importance here:
IP address of the bearer connection
RTP/UDP port of the bearer connection (depending whether it is a voice or data transmission)
Codec(s), that can be/are used for the voice or data transmission
Stream mode of the bearer connection

During connection setup a SIP proxy server can be used, e.g. if the endpoints in the connection do not know each other. It can also be designed to evaluate, modify and/or forward a received request for a client (e.g. an IP telephone, PC or PDA). MG and MGC are also provided at the interface with other networks. The protocol MGCP (Media Gateway Control Protocol) is used to control the MG.

Both architectures have in common the fact that the connection control level and the resource control level are functionally clearly separate from each other and are even frequently implemented on different hardware platforms.

The connection control level is used for the regulated activation, control and deactivation of network services. It can have dedicated connection controllers for this purpose, to which the following functions can be assigned:
Address translation: translation of E.164 telephone numbers and other alias addresses (e.g. computer names) to transport addresses (e.g. Internet addresses).
Admission control: check whether and/or to what extent the communication network can be used.
Alias address modification: Return of a modified alias address, which is used by the endpoints, e.g. for connection setup.
Bandwidth control: Management of transmission capacities, e.g. by controlling the permitted number of devices that can use the communication network at the same time.
Connection authorization: Authorization check for incoming and outgoing connection requests.
Connection control signaling: switching and/or processing of signaling messages.
Connection management: Management of existing connections.
Dialed digit translation: conversion of the dialed digits to an E.164 telephone number or a number from a private numbering scheme.
Zone management: Registration of (e.g. IP-enabled) devices and provision of the above functions for all devices registered with the connection controller.

Examples of connection controllers are the H.323 gatekeeper and the SIP proxy.

The resource control level is used for the regulated implementation of activated services. To control network resources (e.g. transmission nodes) it can comprise resource controllers, to which the following functions can be assigned:
Capacity control: Control of the traffic volume fed in to the communication network, e.g. by checking and if necessary limiting the permitted transmission capacity of individual packet streams.
Policy activation: Reservation of (transmission) resources in the communication network.
Priority management: Preferred transmission of priority traffic streams, e.g. with the aid of priority flags, which are provided in priority packets.

If a larger communication network is divided up into a number of domains—also referred to as zones—a separate connection controller can be provided in each domain. A domain can also be operated without a connection controller. If a number of connection controllers are provided in a domain, just one of them should be activated. From a logic point of view, a connection controller should be seen as separate from the devices. However physically it does not have to be implemented in a separate connection controller device but can also be provided in any endpoint of a connection (for example configured as an H.323 or SIP terminal, media gateway, multipoint control unit) or even a device configured primarily for program-controlled data processing (e.g. computer, PC, server). A physically distributed implementation is also possible.

An alternative example of a connection controller is a Media Gateway Controller, to which generally the optional functions connection control, signaling and connection management are assigned. The assignment of a signaling conversion function for converting different (signaling) protocols is also possible, as may be required for example at the boundary between two different networks, which are combined to form a hybrid network.

The resource controller is also referred to as a ‘Policy Decision Point (PDP)’. It is for example implemented within what are known as edge routers—also referred to as edge devices, access nodes or in the case of assignment to an Internet Service Provider (ISP) also Provider Edge Routers (PER). These edge routers can also be configured as media gateways to other networks, to which the multimedia networks are connected. These media gateways are then connected both to a multimedia network and to the other networks and are used internally to convert between the different (transmission) protocols of the different networks. The resource controller may also be configured simply as a proxy and forward information of relevance to the resource controller to a separate device, where the relevant information is processed according to a function of the resource controller.

In these networks signaling messages are exchanged either via a connection controller (Connection Controller Routed Signaling—CCRS) or directly between the terminals (Direct Endpoint Routed Signaling—DERS). A connection can be specified individually for each terminal and each transmission direction, said variant being used.

In the case of CCRS all signaling messages are transmitted by at least one call controller. All devices send and receive signaling messages solely via the call controller. A direct exchange of signaling messages between the devices is thereby not permitted.

In the case of DERS copies of selected signaling messages can be transmitted to connection controllers, so that with this variant too a connection controller can have knowledge of the connections existing between the terminals. However it does not actively influence or verify these connections.

To summarize, the function split between the two levels can be described such that the resource control level is only assigned the functions required for the transmission of useful information, while the connection control level comprises the intelligence for controlling the resource control level. In other words: the devices of the resource control level have as little network control intelligence as possible and can thus be implemented in a particularly advantageous economic manner on separate hardware platforms. This is a particularly useful advantage due to the larger number of installations in this level compared with the connection control level.

The amalgamation of different networks results in hybrid networks, in which different protocols are used. So that all devices can communicate with each other (e.g. IP-based telephones with PSTN-compatible telephones and vice versa) without restriction in such a network, interworking is required between the respective protocols (e.g. SIP and H.323 in packet-oriented multimedia networks and ISUP and DSS1 in line-oriented PSTN networks). Such interworking should be understood in the broad sense and includes both simple bearer interworking and the interworking of performance features and services such as call hold, call waiting, call redirect, 3PTY (three-party conference), CONF (conference without a limit on the number of conferees) or IVR (Interactive Voice Response).

Interworking between two different protocols can be achieved indirectly or directly. In the case of indirect interworking a further, third protocol is switched between the two protocols—e.g. the protocol BICC (Bearer Independent Call Control) according to the standard Q.1902 or the protocol SIP_T (SIP for Telephones), described in the standard RFC3372. By contrast direct interworking takes place directly between the two different protocols, i.e. without the use of an intermediate protocol.

### SUMMARY OF INVENTION

New technical problems arise both in convergent multimedia networks and in hybrid networks, formed for example by an amalgamation of a convergent multimedia network with a conventional line-oriented voice network, during the transmission of information—in particular in realtime packet streams—due to the new or different technologies used in the respective types of network.

The document U.S. Pat. No. 6,512,818 discloses a method, in which a continuous connection is set up between a first and second subscriber using a Voice Response Unit (VRU), with a first connection being set up first between the first subscriber and the VRU and a second connection being set up between the VRU and the second subscriber, which are then switched together by the VRU to form the continuous connection such that the VRU is no longer part of the switched connection. Ringback to the first subscriber has no response.

The document U.S. Pat. No. 6,574,335 discloses a method, in which a first subscriber, linked via a line-oriented connection to a packet-oriented network, sets up a first connection to a second subscriber. Ringing at the second subscriber is displayed by the second subscriber to the first subscriber with the aid of a ringback message, which is necessary because a line-oriented ringback due to the existing line-oriented connection is not possible. In view of this message, the first subscriber selects a ringback tone that is suitable for the network of the second subscriber from a set of previously stored ringback tones.

If the first connection is redirected to a further subscriber via a gate controller, a second connection is set up to the further subscriber and a further ringback message is sent from there to the initiator of the second connection as part of the setting up of the second connection. Notification of this further ringback to the first subscriber, with which the already accepted first connection still exists, has no response.

The object of the invention is to identify at least one of these problems and enhance the prior art by specifying at least one solution.

The invention is based on the knowledge that during the evolution of hybrid networks, resulting from the interconnection of proven line-oriented networks with modem multimedia networks, many of the long established performance features of line-oriented networks have not or have at least not been fully supported. One reason for this is the large number of new interworking interfaces and protocols, which do not or do not fully support the previous performance features.

The invention is also based on the knowledge that the differentiated parameters for bearer handling in the different PSTN networks and multimedia networks are not compatible. Thus in PSTN networks and H.323 networks for example it is signaled to the partner that their transmit direction is blocked, while in SIP networks it is signaled to the partner that said partner must interrupt the (from the viewpoint of the signaling partner) remote transmit direction, as in SIP networks only the transmit direction, not the receive direction, is isolated and thus every SIP subscriber suppresses their transmit direction themselves by deactivating their transmitter. On the other hand in PSTN networks some signal tones, e.g. ringback, are generated at the B-subscriber and transmitted via the network to the A-subscriber, while in multimedia networks the signal tone should only be generated at the A-subscriber where possible.

The invention recognizes that these divergences mean that even the Intelligent Network services of the PSTN network, such as prepaid services—also referred to as Interactive Voice Response IVR—must be fitted into the complex fabric of merging networks when used in a packet-oriented multimedia network. The invention recognizes that it is thereby no longer possible to transmit ringback tones straight through the packet-oriented multimedia networks as before. The invention also recognizes that it is undesirable to switch connections set up with the aid of IVR systems always via the IVR systems as before.

The IVR service is currently undergoing standardization at the IETF. In the existing draft standard draft-ietf.sipping-3pcc-03.txt there is however no reference to the knowledge in the invention. The problem of ringback tones is not examined. As a result this function is currently lost if the B-subscribers are assigned to the multimedia network and do not therefore feed any ringback tones into the payload stream.

It would in principle be possible to apply a ringback tone to the A-subscriber as a precaution. This solution is however problematic, if the B-subscriber is not available or the setting up of a connection to the B-subscriber fails for other reasons, as a connection setup state would then be simulated for the A-subscriber, which does not correspond to reality. This is not acceptable from the operator's point of view and cannot be offered commercially.

A solution to this problem situation underlying the invention is set out in the claims.

This solution offers a number of advantages:
Notification of ringing at the B-subscriber means that a ringback can be displayed for the A-subscriber.
Notification with the aid of signaling messages means that it is no longer necessary to transmit a ringback tone at the B-subscriber.
Linking ringback to the signaling messages means that ringback is only displayed to the A-subscriber when ringing is actually present at the B-subscriber. This avoids the susceptibility to error of the simulation solution. The solution is therefore acceptable from the operator's point of view and can also be offered commercially.
The implementation of an IVR System in a multimedia network increases acceptance of such modem networks.

Further advantageous embodiments of the invention will emerge from the claims.

By converting the two connections of the IVR system to a direct connection between the two subscribers there is no need for the previous “looping” of the bearer through the IVR system or any replacement of this, thereby significantly reducing the load on the IVR system.

Configuring the first signaling message as the SIP message re-INVITE advantageously satisfies the recommendation of the IETF standard RFC3311, section 5.1, according to which in the case of an existing connection (in this instance the first connection, referred to in the standard as “confirmed dialogue”), a message UPDATE could be sent, but the further sending of an INVITE, in this instance also referred to as “re-INVITE”, is recommended. Specifying detailed SIP messages has the useful advantage that the further drafting of the draft standard draft-ietf-sipping-3pcc-03.txt is significantly simplified.

By transmitting a ringback tone to an A-subscriber, which is assigned to a line-oriented network, the line-oriented devices can continue to be used without modification. This has the useful advantage of a seamless connection of both networks to form a hybrid overall network.

Displaying an information window means that the method can be used in an optimum manner on terminals with displays, such as computers, mobile phones, etc.

### BRIEF DESCRIPTION OF THE DRAWING

The invention is described in more detail below based on further exemplary embodiments, which are also shown in the FIGURE, in which:

FIG. 1 shows an exemplary arrangement for implementing the claimed method with a hybrid communication network, comprising two packet-oriented multimedia networks and a line-oriented voice network, connected by intermediate media gateways, media gateway controllers and SIP proxies, and an endpoint of a common performance feature in each of the three networks.

### DETAILED DESCRIPTION OF INVENTION

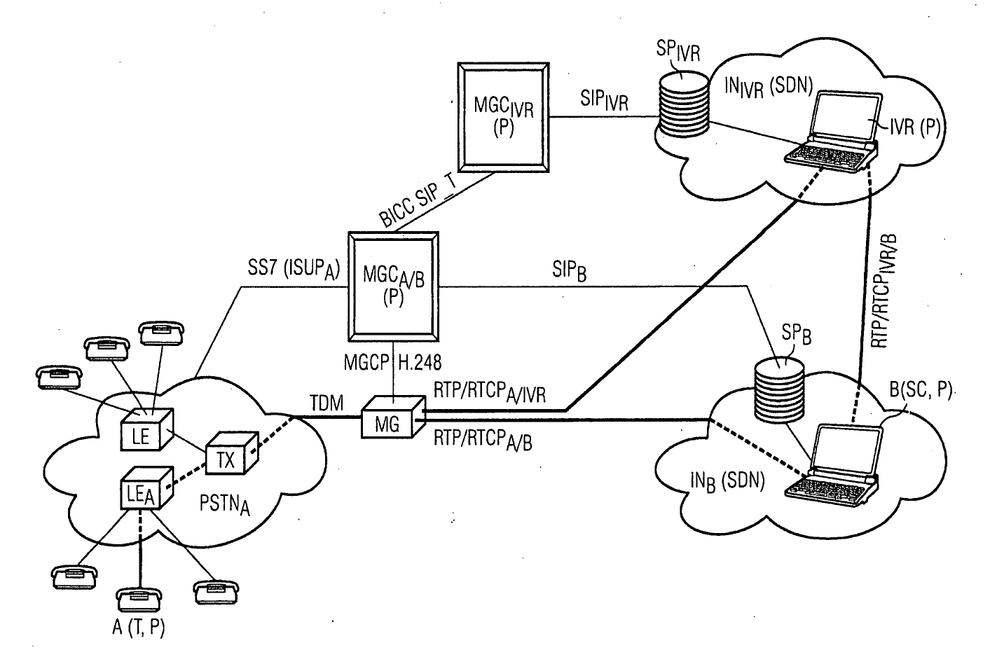

FIG. 1 shows an exemplary arrangement for implementing the claimed method. It comprises a line-oriented network PSTN_{A} and two multimedia networks IN_{B} and IN_{IVR}, preferably configured as integrated voice/data networks SDN. The networks PSTN_{A}, IN_{B} and IN_{IVR} are amalgamated to form a hybrid network. The networks IN are preferably configured as IP networks and have an SIP proxy SP_{B} or SP_{IVR} as the call controller in each instance. For the person skilled in the relevant art it is clear that the invention can of course be used in any packet-oriented networks IN, such as Internet, Intranet, Extranet, H.323 network with a gatekeeper as call controller, a local network (Local Area Network—LAN) or a corporate network configured as a Virtual Private Network (VPN).

A subscriber A is linked to the network PSTN_{A} with the aid of a conventional telephone T and a subscriber B is linked to the network IN_{B} with the aid of a SIP-enabled telephone—e.g. a SIP client in software form. An Interactive Voice Response System IVR is assigned to the network IN_{IVR}. Between subscriber A and the IVR system a first connection is provided, having an end-to-end useful channel TDM, RTP/RTCP_{A/IVR} as bearer. Between the system IVR and subscriber B a second connection is provided, having an end-to-end useful channel RTP/RTCP_{IVR/B} as bearer. Finally a direct connection is provided between subscribers A and B, having an end-to-end useful channel TDM, RTP/RTCP_{A/B} as bearer.

The amalgamation of the line-oriented bearers TDM with the packet-oriented bearers RTP/RTCP is achieved by means of an intermediate Media Gateway MG for converting between different, network-specific useful channel technologies RTP/RTCP (Real Time [Control] Protocol) and TDM (Time Division Multiplex) and the amalgamation of the signaling SS7 of the network PSTN with the signaling SIP of the networks IN is achieved by means of intermediate Media Gateway Controllers MGC_{A/B} and MGC_{IVR}. The controller MGC_{A/B} thereby effects direct interworking between the different network-specific signaling protocols ISUP of the network PSTN and SIP_{B} of the network IN_{B}. In contrast a protocol BICC or SIP_T is used between the controllers MGC_{A/B} and MGC_{IVR} for indirect interworking between the different signaling protocols ISUP of the network PSTN and SIP_{IVR} of the network IN_{IVR}.

The gateway MG is controlled by the controller MGC_{A/B} assigned to it by means of a—preferably internationally standardized—protocol, e.g. MGCP (Media Gateway Control Protocol) or H.248. It is generally implemented as a separate unit, which operates on a different physical device/hardware platform from the controller MGC_{A/B} assigned to it.

It should be pointed out that the embodiments of the invention thus detailed are only of an exemplary nature and should not be seen as restrictive, despite their in some instances very realistic representation of specific network scenarios. It is clear to the person skilled in the art that the invention functions with all conceivable network configurations, in particular other interworking scenarios. In particular the protocols SIP can be replaced by protocols of the H.323 family or other protocols to the same effect.

An exemplary embodiment of the invention is described below, in which the PSTN subscriber A sets up a connection to the SIP subscriber B with the aid of the system IVR as a performance feature.

First of all a first connection TDM, RTP/RTCP_{A/IVR} is set up between the subscriber A and the system IVR, which is assigned to the packet-oriented network IN_{IVR}. Because the subscriber A is assigned to the line-oriented network PSTN, during the transition between the networks the latter's line-oriented signaling ISUP is mapped onto the packet-oriented signaling SIP and SIP_T and its line-oriented bearer TDM is converted to the packet-oriented bearer RTP/RTCP_{A/IVR} (and vice versa). For example the SIP signaling SIP:Invite is mapped during interworking between the protocol ISUP and the protocol SIP onto the ISUP signaling O:IAM. The ISUP signalings O:ACM and O:ANM, are similarly mapped onto the SIP messages 180:Ringing and 200:OK. The first connection thus set up comprises at least one (in the case of a telephone call generally bi-directional) bearer TDM, RTP/RTCP_{IVR} for the transmission of information between the subscriber A and the system IVR.

The necessary data required for authentication of the subscriber A and to identify the subscriber B is then notified to the system IVR by the subscriber A. For example the subscriber A transmits a pass code and the call number of the subscriber B on the bearer TDM, RTP/RTCP_{A/IVR}.

The system IVR then sets up the second connection RTP_{IVR/B} to the subscriber B using the notified data. The results at the B-subscriber in the display of a ringing. This is notified to the system IVR. The system IVR then sends a first signaling message to the subscriber A. On receipt of this message the subscriber A is informed of the ringing at the subscriber B with the aid of a ringback. In this exemplary embodiment the subscriber A is assigned to the network PSTN, so that the transmission of a ringback tone is desirable. This ringback tone is preferably generated in the Media Gateway MG. To this end the first signaling message is received by the Media Gateway Controller MGC_{A/B} and translated by the latter into an instruction to generate the ringback tone, which is transmitted with the aid of the protocol MGCP to the Media Gateway MG. Alternatively the ringback tone could also be transmitted directly by the system IVR instead of the first signaling message, if the system IVR knows the network type to which the subscribers A are respectively assigned. This could be known for example based on fixed presettings.

As soon as the subscriber B accepts the set up connection, this is notified to the subscriber A with the aid of a second signaling message. This is also received by the Media Gateway Controller MGC_{A/B} and translated by this latter into an instruction to disable the ringback tone, which is transmitted with the aid of the protocol MGCP to the Media Gateway MG. In the alternative embodiment the ringback tone would be disabled immediately by the system IVR. This terminates ringback at the subscriber A. Ringback and ringing are thus aligned in a consistent manner.

The two connections TDM, RTP/RTCP_{A/IVR} and RTP/RTCP_{IVR/B} in the packet-oriented network IN are advantageously converted to a direct connection TDM, RTP/RTCP_{A/B} at the latest on acceptance of the second connection RTP/RTCP_{IVR/B}. This is achieved for example by transmitting the IP addresses of the subscribers A, B in the relevant messages. For example the IP addresses could be transmitted in SIP messages INVITE, re-INVITE, 180 RINGING, 200 OK or ACK in appropriate SDP attributes in each instance.

The sender of the second signaling message is dependent on when the conversion of the two connections to a direct connection takes place. If it takes place earlier, at the start of setup of the second connection, the sender is probably directly the subscriber B. If it takes place later, the direct sender is more likely to be the system IVR, to which a corresponding (indirect) message has previously been sent by the subscriber B—e.g. a SIP message 200 OK.

To summarize and related generally to the subscribers A, which are assigned to any network, the individual steps from the setting up of the second connection are as follows:

| Subscriber A or | First | |
|---|---|---|
| Media Gateway MG | connection | Second connection |
| | | INVITE |
| | | (Setup to subscriber B) |
| Ringback tone is applied | re-INVITE | 180 RINGING (without SDP) |
| or information window is | (with alert info) | (subscriber B is called) |
| displayed | Mapped or | With or without alert info |
| | default value | |
| | used | |
| | 200 OK | |
| | ACK | |
| Ringback tone is disabled | re-INVITE | 200 OK |
| or information window is | (without alert | (subscriber B accepts call) |
| closed | info) | |
| | 200 OK | |
| | ACK | |

It is clear to the person skilled in the art that the invention functions with all relevant network configurations, in particular all interworking scenarios TDM [symbol] IP. It is also clear to the person skilled in the art that the invention can also be used, when there is no ISUP, BICC between the PSTN subscribers (ISDN, analog subscriber or even mobile radio subscriber) and the SIP or SIP-T subscribers. The above-mentioned method would then generally operate within switching centers. The interworking of NGN (Next Generation Network) subscribers such as VoDSL (Voice over Digital Subscriber Line), H323, etc. with SIP or SIP-T is thus also possible.

To conclude, it should be noted that the description of the components of the communication network of relevance to the invention are in principle not to be seen as restrictive. It is clear to a person skilled in the relevant art in particular that terms such as subscriber, gateway, controller, etc. are to be understood functionally rather than physically. All the function units can be implemented in particular partially or wholly in software/computer program products P and/or in a distributed manner using a number of physical devices.

1.-9. (canceled)

10. A method for setting up a connection between a first subscriber device and a second subscriber device using an Interactive Voice Response (IVR) system assigned a packet-oriented communication network, comprising:
setting up of a first connection between the first subscriber device and the IVR system;
acceptance of the first connection, the first connection comprising a bearer for the transmission of information between the first subscriber device and the IVR system;
setting up of a second connection between the IVR System and the second subscriber device;
informing the second subscriber device about the setting up of the second connection via ringing the second subscriber device;
notification of the ringing to the IVR system;
notification of the ringing to the first subscriber device by transmitting a first signaling message from the IVR system;
informing the first subscriber device about the ringing at the second subscriber device via a ringback;
acceptance of the second connection by the second subscriber device;
notification of acceptance to the first subscriber device by transmitting a second signaling message; and
termination of the ringback.

11. The method according to claim 10, further comprises transmitting a call number of the second subscriber device to the IVR system from the first subscriber device.

12. The method according to claim 11, further comprises converting the first and second connections to a direct connection between the first and second subscriber devices without the use of the IVR system in response to the acceptance of the second connection.

13. The method according to claim 12, wherein the second signaling message is transmitted by the IVR system.

14. The method according to claim 12, wherein the second signaling message is transmitted by the second subscriber device.

15. The method according to claim 12, wherein the sender of the second signaling message is determined based on a time of conversion of the first and second connections to the direct connection.

16. The method according to claim 12,
wherein the first and second signaling messages are formed in accordance with a SIP protocol,
wherein the first signaling message is formed as re-INVITE with an alert info, and
wherein the second signaling message is formed as re-INVITE without an alert info.

17. The method according to claim 16, wherein the SIP protocol is based on an IETF standard selected from the group consisting of RFC2543, RFC2543bisOx, RFC3261 and RFC3372.

18. The method according to claim 11, wherein the ringing of the second subscriber device is via an information window.

19. The method according to claim 11, wherein the notified ringing is displayed to the first subscriber device with the aid of an information window.
